(19) United States
(12) Patent Application Publication
(10) Pub. No.: US 2014/0020487 A1
(43) Pub. Date: Jan. 23, 2014

(54) AXIALLY LOCATED BOLT GUIDE CAP

(71) Applicants: Robert Linford Neidlinger, II, Royal Oak, MI (US); Matthew James Fenton, Milford, MI (US); Andrew Robert Weiser, Plymouth, MI (US)

(72) Inventors: Robert Linford Neidlinger, II, Royal Oak, MI (US); Matthew James Fenton, Milford, MI (US); Andrew Robert Weiser, Plymouth, MI (US)

(73) Assignee: ZF Steering Systems, LLC, Northville, MI (US)

(21) Appl. No.: 13/552,875

(22) Filed: Jul. 19, 2012

(51) Int. Cl. G01D 21/00; B62D 3/12

(52) U.S. Cl. 74/89.17; 33/600

(57) ABSTRACT

A guide cap axially aligns a yoke to an input shaft of a steering system. A cap body has an opening receiving an end of the input shaft. A cap fin guides seating of the yoke to the input shaft by mating to a yoke slit. A finger projection engages a radial recess in the input shaft with a retention force opposing axial removal of the guide cap once installed. A fin notch provides limits to relative axial displacement between the guide cap and yoke and guides axial positioning of the yoke as the yoke bolt is installed, deterring inadvertent threading into the input shaft. The fin anchor mates to a notch of the input shaft providing stability to the fin relative to the input shaft, and fixing rotational position of the guide cap on the input shaft.

### BACKGROUND OF THE INVENTION

This invention generally relates to an input shaft cap for a steering system, and more particularly to a guide cap for aligning an intermediate shaft's connector to an input shaft in a steering system.

Many modern cars use rack and pinion steering mechanisms, where the steering wheel turns the pinion gear of a pinion, and the pinion in turns moves the rack. The rack is a linear gear that meshes with the pinion, converting circular motion into linear motion along the transverse axis of the car (side to side motion). This motion applies steering torque to the swivel-pin ball joints of the stub axle of the steered wheels via tie rods and a short lever arm called the steering arm. In such rack and pinion steering systems, the steering wheel and steering column are linked to the pinion gear via an intermediate shaft and an input shaft. The intermediate shaft is connected to the input shaft with a yoke. A proper connection between the yoke and input shaft is needed to maintain steering control of the vehicle. The guide cap of the present invention serves to assure a proper connection between the yoke and the input shaft by serving as a guide during installation and by exerting a high retention force to resist axial separation after installation. These and other needs are addressed by various embodiments of the present invention.

### SUMMARY OF THE INVENTION

A guide cap of the present invention is part of a steering system having a yoke seated at an end of an input shaft. The guide cap also is seated at the end of the input shaft and serves to align the yoke to the input shaft, while also contributing to the anchoring of the yoke to the input shaft. The guide cap includes a cap body and a fin. The cap body is anchored to the input shaft by a plurality of input shaft engaging members and a fin anchor. Each input shaft engaging member includes a protrusion extending radially inward to sit in a radial recess, such as a circumferential groove, of the input shaft. The fin anchor extends from a portion of the fin into a longitudinal groove of the input shaft, and provides stability to the fin. The projections provide a desired retention force for resisting axial separation of the yoke and guide cap, once installed.

The guide cap, and in particular the fin, serves as an alignment guide for the yoke during installation. The guide cap is installed first. The axial position of the guide cap is fixed relative to the input shaft within a prescribed tolerance by the input shaft engaging members and the fin anchor. The rotational position of the guide cap is fixed relative to the input shaft by a flat portion of the cap body inner surface, which correlates to a flat portion of the input shaft surface. The inner surface of the cap body and the outer surface of the input shaft are asymmetrical so that when the specific, correlated flats align the cap is installed properly (as opposed to being 180 degrees, or some other arc distance, out of alignment). Secondarily, the rotational position of the cap is fixed relative to the input shaft by the fin anchor mated into the longitudinal groove of the input shaft. The yoke then is installed onto the input shaft and guide cap using the guide cap as a guide for properly aligning the yoke. The yoke includes a slit extending radially and longitudinally. As the yoke is being installed at the end of the input shaft, the slit is aligned with the fin, so that the fin enters the slit as the yoke is moved axially.

The yoke is secured relative to the guide cap and input shaft by a yoke bolt. The yoke includes a bolt channel extending transversely to each side of the slit. The input shaft includes a whistle notch. The yoke bolt channel is rotationally aligned to the whistle notch when the fin is aligned with the slit. The yoke bolt is threaded through at least part of the yoke bolt channel adjacent to and aligned with the whistle notch. The fin includes a fin notch so that the fin does not interfere with the yoke bolt channel when proper alignment occurs. When the fin sits within the slit, the fin notch accommodates the yoke bolt. The fin notch provides axial limits for aligning the yoke bolt and aids in assuring that the yoke bolt is aligned to the axial position of the whistle notch. The yoke bolt is secured in the bolt channel, and thus the axial position of the yoke bolt may determine the fine axial positioning of the yoke. The fin notch limits the range of such fin axial positioning of the yoke. The bolt secures the yoke to the input shaft when properly aligned within the whistle notch.

The guide cap provides alignment for setting limits to the axial, radial and rotational position of the yoke relative to the input shaft so that a proper connection between the yoke and input shaft can be established and maintained. In particular, the cap fin serves as a rotational alignment guide during installation of the yoke. The fin assures that the yoke is not installed backwards (i.e. 180 degrees out of alignment), and provides alignment to tolerance when installed correctly.

As the yoke is moved axially onto the input shaft during installation, the yoke is blocked from further proximal advancement by a seat at the input shaft. Such seat is formed by a transition region where input shaft diameter changes from a narrow diameter (to which the yoke conforms) to a larger diameter. The yoke may be axially displaced slightly during installation to allow the yoke bolt channel to be in axial alignment with the whistle notch. The fin notch serves as a guide for preferred limits of axial displacement of the yoke relative to the cap while the yoke bolt is being installed as it transversely passes through the fin notch.

The inventions will be better understood by reference to the following detailed description taken in conjunction with the accompanying drawings.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is a perspective view of an exemplary rack and pinion steering system for which the guide cap of the present invention may be used;

FIG. 2 is a perspective view of a portion of a steering system according to an embodiment of the present invention;

FIG. 3 is a diagram of a yoke bolt properly seated relative an input shaft;

FIG. 4 is a diagram of a yoke bolt improperly positioned relative to the input shaft;

FIG. 5 is a planar view of a bolt guide cap according to an embodiment of the present invention;

FIG. 6 is a cutaway view of the bolt guide cap of FIG. 5 showing the cap body and skirt;

FIG. 7 is a perspective view of the bolt guide cap according to another embodiment of the present invention;

FIG. 8 is a first planar view of the bolt guide cap of FIG. 7;

FIG. 9 is a second planar view of the bolt guide cap of FIG. 7;

FIG. 10 is a third planar view of the bolt guide cap of FIG. 7;

FIG. 11 is a cutaway view of the bolt guide cap of FIG. 7 seated to an end of the input shaft;

FIG. 12 is a diagram of a yoke;

FIG. 13 is another diagram of the yoke;

FIG. 14 is a top view of a yoke;

FIG. 15 is a perspective view of a bolt guide cap having a fin being fitted to the notch of the input shaft; and

FIG. 16 is a diagram of a seating relationship between an input shaft, guide cap and yoke, according to an embodiment of the present invention.

### DETAILED DESCRIPTION OF THE INVENTION

In the following description, for purposes of explanation and not limitation, specific details may be set forth to provide a thorough understanding of the present invention. However, it will be apparent to one skilled in the art that the present invention may be practiced in other embodiments that depart from these specific details. Detailed descriptions of well-known components are omitted so as not to obscure the description of the present invention.

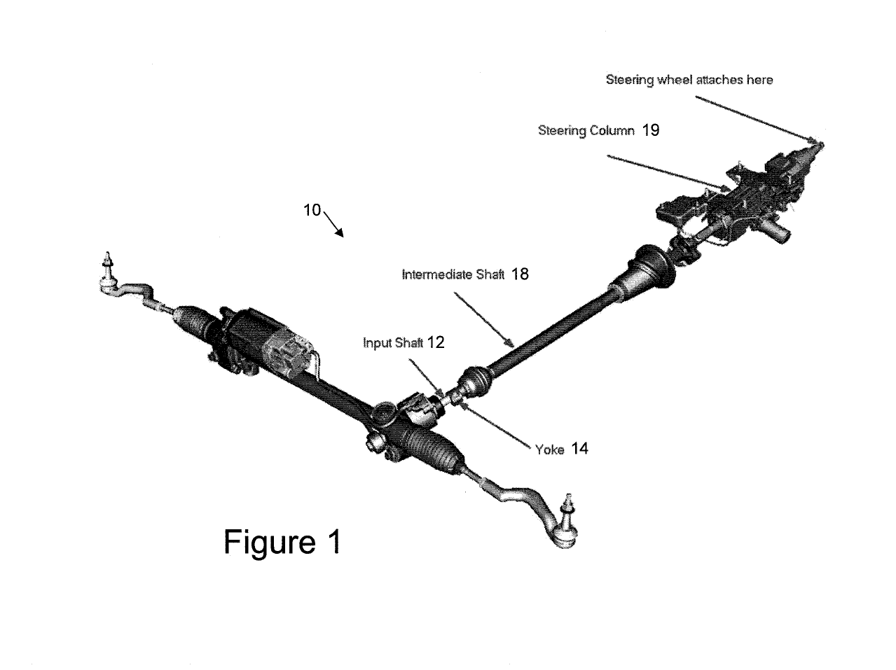

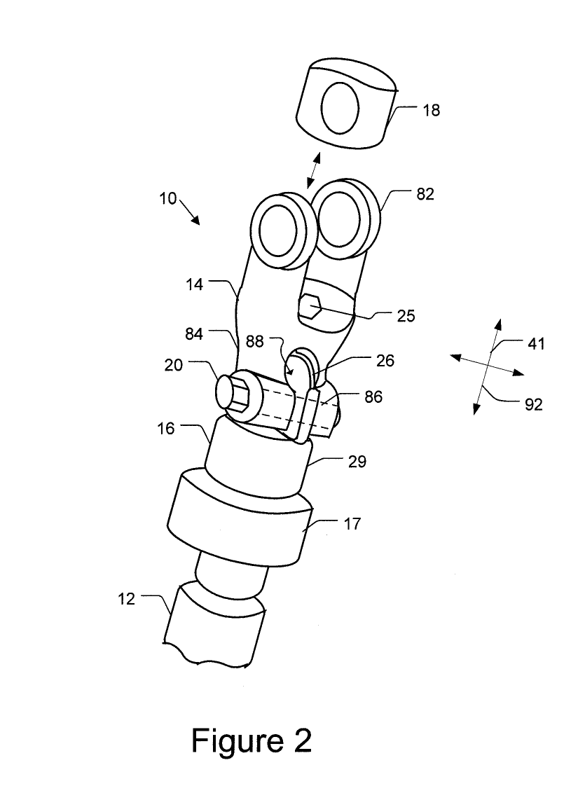

FIG. 1 shows a portion of an exemplary steering system 10 with which the bolt guide cap may be used. Although suitable for use with various steering systems, an exemplary rack and pinion steering system 10 includes an input shaft 12 that couples to a pinion gear. A driver controls vehicle steering by turning a steering wheel. The steering wheel is coupled to a steering column, which in turn is coupled to an intermediate shaft 18. A yoke 14 connects the intermediate shaft to the input shaft 12. When a driver turns the steering wheel, the yoke 14 rotates relative to the axis of the input shaft 12 based on linkages through the steering column and intermediate shaft 18. The yoke 14 is substantially fixed relative to the input shaft 12 and intermediate shaft 18. Accordingly, rotation of the yoke 14 causes the input shaft 12 to rotate. The pinion gear in turn translates the rotation into lateral movement for adjusting the position of the wheels. For example, in a front wheel drive system, the front wheels are moved. FIG. 2 shows a portion of the steering system 10, including the input shaft 12, yoke 14, and a guide cap 16, according to an embodiment of the present invention. Also shown is an umbrella cap 17 that is stretched over a groove of the input shaft 12.

### The Problem Identified

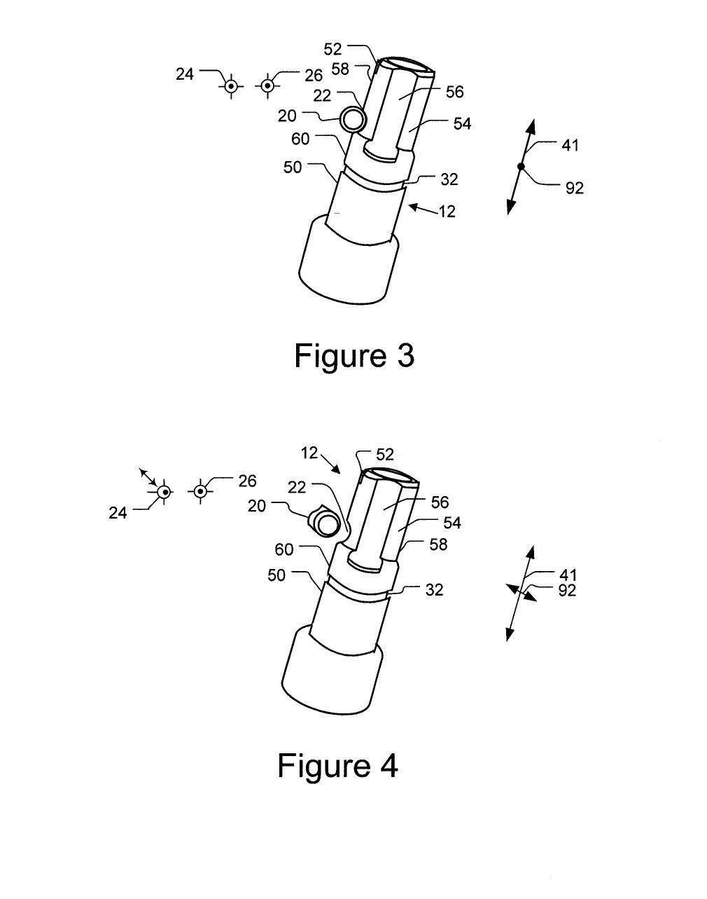

For a driver to maintain steering control of a vehicle, the steering column needs to remain coupled to the input shaft 12 and the rest of the steering system 10. A yoke 14 is seated at the end portion of the input shaft 12. If the yoke is not properly seated and secured, vehicle steering control may be lost. The yoke 14 is secured to the input shaft 12 by a yoke bolt 20. FIG. 3 shows a relative position of the input shaft 12 and yoke bolt 20. The input shaft 12 has a crescent shaped cut out, referred to as a whistle notch 22. The whistle notch 22 has generally the same contour or a more open contour as a portion of the yoke bolt 20 (not accounting for bolt threads). Upon proper installation, the yoke bolt 20 sits in the whistle notch 22. In particular, a longitudinal direction 24 (depicted as a target into the paper) of the yoke bolt 20 will be substantially parallel to a tangent 26 (depicted as a target into the paper) of the whistle notch surface in a transverse direction (generally perpendicular to the input shaft axis). Because the contours of the yoke bolt 20 and whistle notch 22 generally conform to each other, upon proper installation, axial displacement of the bolt 20 relative to the input axis 12 can be prevented.

A problem arises however, in a case where the yoke 14 does not have the proper axial or rotational alignment with the input shaft 12 during installation. In a case where there is a rotational offset, the longitudinal direction 24 (shown as a target and arrow offset from the plane of the paper) of the yoke bolt 20 is not substantially parallel to the tangent 26 (shown as a target into the paper) of the whistle notch 22, as shown in FIG. 4. As a result, the yoke bolt 20 is rotationally offset relative to the whistle notch 22 and can dig into the input shaft during installation. In particular when the yoke bolt 20 is secured it will thread into the input shaft 12. Similarly, the bolt 20 can thread into the input shaft 12 when the yoke 14 and yoke bolt 20 are axially displaced. Such threading disguises as a proper securing of the yoke 14 to the input shaft 12. For example, the torque created by threading the yoke bolt 20 into the input shaft 12 may fool the plant operator into thinking that the bolt 20 has been properly torqued down. However, when misaligned the yoke bolt 20 is not fit to the whistle notch 22, and therefore the yoke 14 may not be adequately secured to the input shaft 12. As a result, the yoke 14 may be displaced either rotationally and/or axially relative to the input shaft 12 upon installation and allow for changes in such displacement during the life of the vehicle. Even if the yoke moves rotationally after installation so that the yoke bolt 20 moves into the whistle notch 22, the deformed input shaft 12 (resulting from threading the bolt into the shaft) may allow positional an undesirable amount of play between the yoke 14 and input shaft 12 diminishing steering control by the driver. Further, it is possible that steering control may be lost due to a failed alignment. For example axial separation between the yoke 14 and input shaft 12 potentially may occur resulting in complete loss of steering control. Applicants guide cap 16 serves to assure that the yoke 14 is properly seated on the input shaft with the yoke bolt 20 properly aligned within the whistle notch 22 upon installation and over the continued operation of the vehicle.

The guide cap 16 addresses the problem of axial displacement of the guide cap 16 and yoke 14 relative to the input shaft 12 with input shaft engaging members. Rather than relying upon a tight fitting cap as a means for keeping the cap from sliding axially off the input shaft, the engaging members 28 provide a strong retention capability preventing axial displacement. As a result tolerances for the snugness of the fit of the cap may be relaxed.

### Guide Cap 16

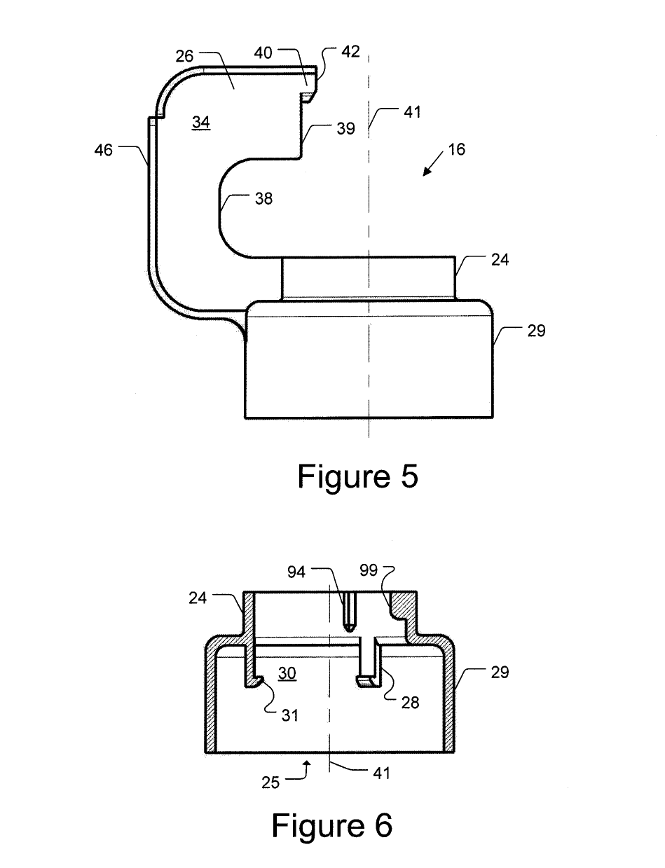

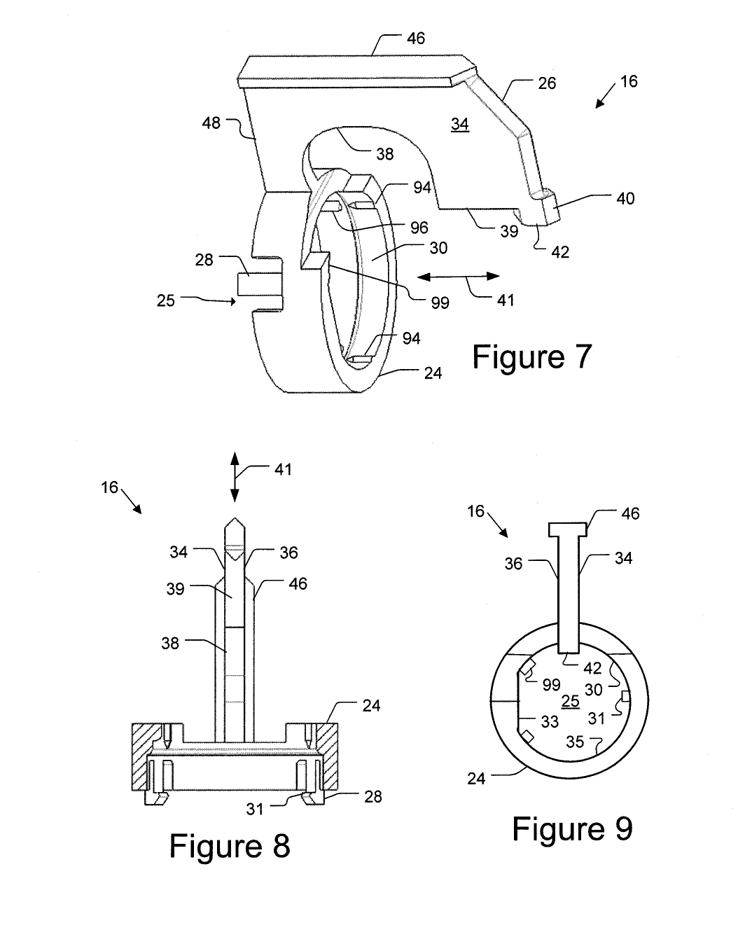

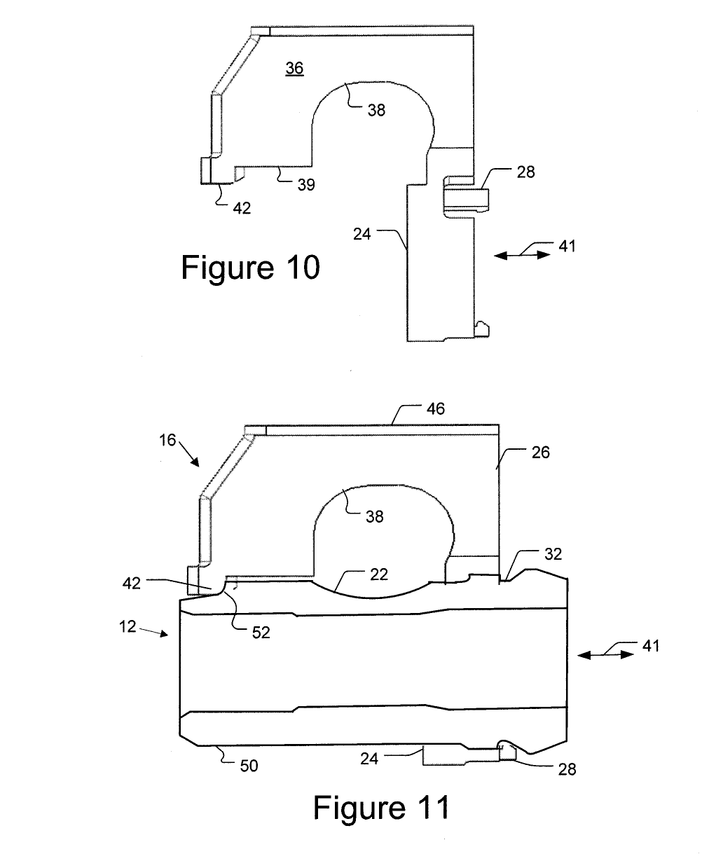

The guide cap 16 serves to assure proper installation and alignment of the yoke 14 to the input shaft 12. FIGS. 5-6 (and 15-16) show a guide cap 16 according to an embodiment of the present invention. FIGS. 7-11 show a guide cap according to another embodiment of the present invention. Like parts are given like numbers. Further, the first embodiment is substantially the same as the second embodiment, while also including a skirt portion 29.

The guide cap 16 includes a cap body 24 and a fin 26, and in some embodiments also includes a skirt 29 (e.g., see FIGS. 1, 5 and 6). The cap body 24 is generally ring shaped having a through opening 25 bordered by an inner circumferential wall surface 30 (see FIG. 9). Although a generally smooth, generally cylindrical outer surface is depicted of the cap body, other outer surface shapes may be implemented. Of significance is that the inner wall surface 30 generally conforms to a corresponding circumferential surface portion of the input shaft 12. For example, the circumferential wall 30 has generally a circular arc shape conforming to a circular arc shape of the input shaft 12. In a preferred embodiment, the input shaft end portion receiving the guide cap 16 may also have a circumferentially flat portion 33 (as distinguished from the arc shape of another portion(s) or a remaining portion 35 of the circumference). See FIG. 9. Most preferably, the cap body inner wall 30 has an asymmetrical contour corresponding to an asymmetrical contour of the input shaft, so as to assure that the cap is installed correctly (e.g., as opposed to being installed backwards or by some other offset arc distance). The corresponding surfaces allow for a coarse rotational alignment between the cap body 24 and the input shaft 12.

As part of the cap body 24, or extending from the cap body 24, are one or more input shaft engaging members 28. In one embodiment the members 28 are deflectable fingerlike projections, although other shapes and structures also are contemplated. Of significance is that each member 28 includes a protrusion 31 that extends radially inward to a point more inward than the cap body's 24 inner circumferential wall surface 30. Such protrusion 31 aligns to a circumferential groove 32 in the input shaft 12. See FIGS. 3, 4 and 11. In a sample embodiment each member 28 provides an estimated 780 N retention force.

The fin 26 extends radially outward from the cap body 24 and extends longitudinally to a distance exceeding the length of the cap body 24. The fin 26 has a generally planar first surface 34 at one side and another generally planar surface 36 at an opposite side. Such planar surfaces 34, 36 may be parallel, or in other embodiments may have different normal vectors. Along a radially inward edge 39 is formed a notch 38 having an arc contour, (e.g., for accommodating in cross section the yoke bolt fin). Distally beyond the fin notch 38, a portion of the radially inward edge 39 is generally straight and extends in the axial direction 41. At a distal portion 40 beyond the cap body 24 in a longitudinal direction, the fin 26 includes an anchor member 42, referred to herein as a fin anchor. The fin anchor 42 extends radially inward of the longitudinally extending portion of the edge 39. Such fin anchor 42 also extends radially inward in a manner making it radially inward of the ring member's inner surface 30. See FIG. 6. The fin 26 also may include a spine 46 wider than a main portion 48 of the fin 26. The spline 46 adds stiffness to the fin 26 so as to minimize or avoid deflection of the fin before or during installation of the guide cap. The spine 46 also serves as a shield for blocking debris from the area of the yoke slit. In a sample embodiment the spine to yoke clearance upon installation is 2.0-4.0 mm, although other clearances and tolerances may be implemented.

### Input Shaft 12 and Yoke 14

Referring to FIGS. 3-4, the input shaft 12 includes an end portion 50, which receives the guide cap 16 and yoke 14. A longitudinal groove 52 is formed at a distal end of the end portion 50 extending radially inward along an arc portion of the distal end circumference. See FIGS. 3, 4, 11 and 15. Although the longitudinal groove is longer longitudinally than circumferentially in the illustrated embodiment, in other embodiments the groove may be the same or longer in the circumferential direction. The axial length of the longitudinal groove 52 is sufficient to allow the fin anchor 42 to seat into the longitudinal groove 52. The circumferential length of the groove 52 preferably is a close fit to the corresponding width of the fin anchor 42. In the sample embodiment the groove 52 width is 2.2 mm and the fin width is 1.9 mm so that the clearance between the fin anchor 42 and the circumferential walls of the groove 52 are 0.15 mm. The fin anchor 42 extends into the groove 52. In the sample embodiment the fin anchor 42 abut the radially inner surface of the groove 52. The groove depth for such sample embodiment is 1.65 mm, although the specific depth may differ being lesser or greater in other embodiments. The fin anchor 42 situated in the groove 52 prevents fin wobble and provides a secondary prevention of cap rotation.

In some embodiments the end portion 50 includes a generally smooth circumferential surface 54. Over a portion of the axial length of the end portion 50, the circumferential surface 54 includes one or more flat portions 56. In addition, the whistle notch 22 is formed in the end portion 50. In some embodiments the end portion 50 includes a distal portion 58 of a first radius (measured relative to an arc shaped portion of the circumferential surface 54) and a proximal portion 60 having a larger radius (as similarly measured relative to an arc shaped portion of the circumferential surface 54). The groove 32 is formed in the proximal portion 60. In a sample embodiment the circumferential groove 32 has a depth of 0.75 mm and the projection 31 of the input shaft engaging member 28 has a corresponding radial length of 0.75 mm for occupying the entire depth of the groove 32, so as to maximize retention capability. The axial span of each projection 31 is shorter than the axial length of the circumferential groove 32, to allow a minimal prescribed axial play between the cap 16 and input shaft 12. In the sample embodiment the amount of play is approximately 0.35 mm, but the specific amount of play may vary in other embodiments. In some embodiments the groove 32 spans an entire circumference of the end portion 50. In other embodiments the groove 32 spans less than the entire circumference of the end portion 50. In such other embodiments there may be one or more grooves 32 along the circumference. Although the groove 32 is depicted on the proximal portion 60, the groove(s) 32 may be formed instead in the distal portion 58, and may be located on either or both of the surfaces 54, 56.

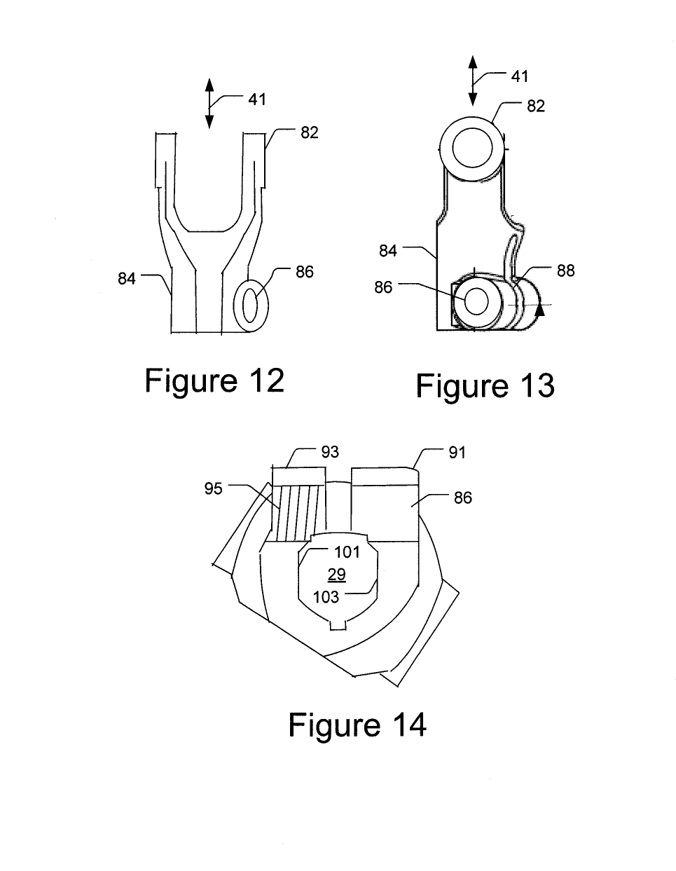

Referring to FIGS. 2 and 12-14, the yoke 14 includes a distal portion 82 to which the intermediate shaft 18 connects, and a proximal body 84 for receiving the end portion 50 of the input shaft 12. The proximal body 84 includes an axial channel 29, a yoke bolt channel 86 and a slit 88. The axial channel 29 extends in an axial direction 41, as defined by the axial length of the input shaft 12, and receives the end portion 50 of the input shaft 12. The yoke bolt channel 86 extends in a transverse direction 92 generally perpendicular to an axial direction 41, and receives the yoke bolt 20. The slit 88 extends from an outer surface of the yoke 14 radially inward to the axial channel 29. When the yoke 14 is properly aligned, the slit 88 opens to the axial channel 29 meeting an area where the whistle notch 22 of the input shaft 12 is located.

The slit 88 intersects the yoke bolt channel 86, and spans an axial length that in some embodiments is longer than a diameter of the yoke bolt channel 86. The slit 88 divides the yoke bolt channel 22 into two lengths. In an example embodiment, the yoke bolt 20 enters the yoke bolt channel 86 at an opening, traverses a first length 91 of the channel 86, traverses the intersecting portion of the slit 88, then traverses a second length 93 of the channel 86. In a preferred embodiment the first length 91 is not threaded and the second length 93 is threaded. Such second length includes threads 95, which correspond to threads on the yoke bolt 20. As the yoke bolt 20 is tightened to a desired torque by threading to the threads 95 of the yoke bolt channel 86, the diameter of the axial channel 25 is slightly decreased tightening the yoke 14 to the input shaft 12.

The yoke 14 may have a symmetrical inner surface along the axial channel 29, such as including two symmetrically opposed flats 101, 103, as shown in FIG. 14. The end portion 50 also may have two symmetrically opposed flats along its outer circumference. As a result it is possible to install the yoke backwards. The fin 26 serves as a guide during installation preventing such backwards installation.

As the yoke 14 is installed onto the input shaft 12, the yoke 14 is blocked from further advancement by a seat 109 on the input shaft (See FIG. 16). Such seat is formed by a transition region where input shaft diameter changes from a narrow diameter (to which the yoke conforms) to a larger diameter. In an example embodiment the seat is formed by as a 0.6 mm bore. The yoke 14 may be axially displaced slightly during installation to allow the yoke bolt channel 86 to be in axial alignment with the whistle notch 22. The fin notch 38 serves as a guide for preferred limits of axial displacement of the yoke 14 relative to the cap 16 while the yoke bolt 20 is being installed as it transversely passes through the fin notch 38. At its most proximal positioning along the input shaft 12, the yoke 14 sits on the seat 109. The yoke 14 may be displaced relative to the seat 109 during installation as needed for the yoke bolt 20 to align with the whistle notch 22.

### The Guide Cap Aids in Alignment and Provides a High Retention Capability

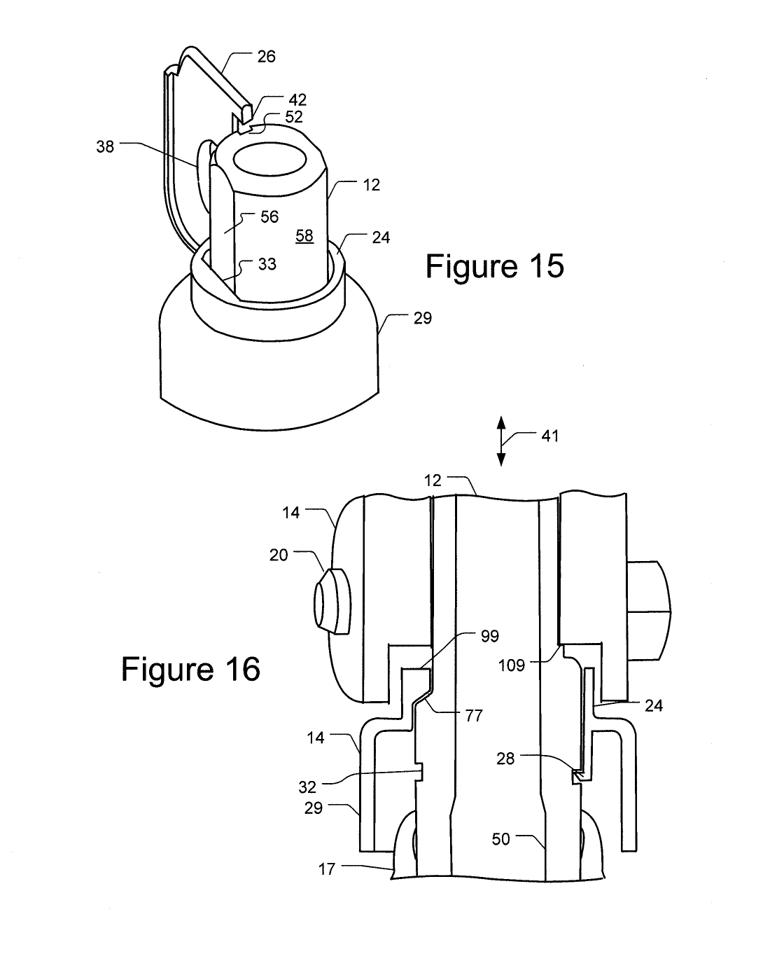

The guide cap 16 first is installed to the input shaft 12 in a manner which limits axial, rotational and radial play between the guide cap 16 and input shaft 12 to within prescribed tolerances. FIG. 15 shows the guide cap 16 in the process of being installed. For the guide cap 16 to fit to the input shaft 12, the flat surface 33 of the cap body inner wall is aligned with a flat surface 56 of the input shaft's 12 peripheral wall. To avoid installing the cap backwards, the cap 16 is positioned so that the fin anchor 42 is to the same side as the input shaft's longitudinal groove 52. The corresponding flat surfaces 33, 56 provide a coarse radial and rotational alignment, allowing a prescribed amount of radial play and rotational play between the guide cap 16 and the input shaft 12. The cap body 24 also may include rigid or deformable ribs 94, 96 extending axially and protruding radially, see FIG. 4, which minimize radial play. The deformable ribs 94, 96 allow for a looser fit between the circumferential wall 30 and the input shaft surface, while filling in a radial separation to achieve contact with the input shaft 12.

Referring to FIGS. 11 and 15, as the guide cap 16 is moved along the input shaft 12 toward its final seated position, the fin anchor 42 mates to the input shaft longitudinal groove 52 providing fine rotational alignment between the guide cap 16 and input shaft 12 within any transverse plane. The lateral walls of the longitudinal groove 52 and fin anchor 42 are machined to tight tolerances to assure such fine rotational alignment. Further, the radially inward face of the fin anchor 42 may be chamfered to ease the mating of the fin anchor 42 into the input shaft longitudinal groove 52 during installation. Also, the depth of the input shaft longitudinal groove 52 limits the radial depth to which the fin anchor 42 may extend, thereby setting the radial position of the fin anchor 42. Thus, fine radial alignment is achieved at the distal end of the fin 26.

The axial distance along the guide cap 16 between the protrusion(s) 31 of input shaft engaging member(s) 28 and the fin anchor 42 is substantially equal to the axial distance between the input shaft groove 32 and the input shaft longitudinal groove 52 within prescribed tolerances (such as for allowing only a minimal amount of play). As the fin anchor 42 is seating to the input shaft longitudinal groove 52, the input shaft engaging member(s) 28 snap into engagement with the input shaft groove 32. For example, as the guide cap 16 slides along the input shaft 12, the input shaft engaging member(s) 28 are deflected, and thereby biased away from their normal relaxed position, by the surface of the input shaft 12. Once the guide cap 16 moves sufficiently far along the input shaft 12, the protrusion(s) 31 encounter the input shaft groove 32 removing all or a portion of the bias. Thus, the input shaft engaging member(s) 28 return toward their normal position with the protrusion(s) 31 resting in the input shaft groove 32. With the input shaft engaging member(s) 28 engaging the input shaft groove 32 and the fin anchor 42 seated in the input shaft longitudinal groove 52, the guide cap 16 is fixed relative to the input shaft. Axial play between the guide cap 16 and input shaft 12 is limited by the fit of the input shaft engaging member(s) 28 in the input shaft groove 32 and the fin anchor in the input shaft longitudinal groove 52. The input shaft engaging members 28 provide a retention force resisting axial separation.

To prevent overshooting the circumferential groove 32 during installation and to set the axial position of the guide cap 16 relative to the input shaft, the guide cap 16 also includes a seating wedge 99, (see FIGS. 7, 9 and 16). While the projections 31 seated in the circumferential groove 32 provide one means of locating the guide cap axially, the seating wedge 99 provides another means. In particular the projections 31 seat into the groove 32 with a prescribed minimal amount of axial play. The seating wedge 99 seats to a corresponding surface 77 on the input shaft 12 (See FIG. 16). The surface 77 blocks further axial movement of the cap body 24 in the installation direction. Installing the guide cap so that the wedge 99 seats to the corresponding surface 77 assures that the guide cap's input shaft engaging members 28 do not overshoot the input shaft's groove 32.

The seating wedge 99 is formed on the cap body 24 extending radially inward beyond the majority portion of the cap body inner wall surface 30. In a sample embodiment the seating wedge 99 is adjacent to the flat surface 33 of the cap body 24. As shown in FIG. 16 the outer surface of the input shaft is asymmetrical. Note that the corresponding surface 77 is more proximal than the transition region discussed above where the yoke seat 109 is located. The axial distance between the yoke seat 109 and the corresponding surface 77 preferably exceeds the longitudinal length of the wedge 99 so that the yoke is axially spaced from a distal surface of the seating wedge 99. In the sample embodiment a 1.84 mm clearance occurs between a distal edge of the wedge 99 and an axially adjacent, corresponding surface of the yoke 14. Accordingly, the yoke 14, if axially seated, seats to the yoke seat 109 not to the wedge 99 or another part of the guide cap 16.

Rotational play between the cap 16 and input shaft 12 is limited by the corresponding flat surfaces 33, 56 and by the fin anchor 42 seated in the input shaft longitudinal groove 52. The protrusions 31 are seated to a prescribed depth in the input shaft's groove 32. Accordingly, the proximal end of the guide cap 16 also achieves fine radial alignment with the input shaft 12. Thus, radial play of the guide cap 16 is limited by the fin anchor 42 seated to a prescribed depth in the input shaft longitudinal groove 52, and by the protrusion(s) 31 seated to a prescribed depth of the input shaft groove 32. Accordingly, the axial, radial, and rotational position of the fin 26 and the fin notch 38 are precisely set relative to the input shaft with minimal prescribed play.

Next, the yoke 14 is installed. Given the minimal play between the guide cap 16 and input shaft 12, the yoke 14 may be precisely positioned relative to the input shaft 12 by aligning the yoke 14 precisely with the guide cap 16. With the guide cap 16 in place, the yoke 14 is slid onto the end portion 50 of the input shaft 12. The input shaft 12 mates to the axial channel 29 of the yoke 14. In an example embodiment, the axial channel 29 also may have flat portions and intermediary arc portions defining its surrounding wall. For the yoke 14 to fit to the input shaft 12, the flat surfaces of the yoke's axial channel wall are aligned with the flat surfaces 56 of the input shaft 12 peripheral wall. The guide cap's fin 26 limits the yoke position to one of the two positions where the yoke 14 could slide onto the input shaft 14. The corresponding flat surfaces of the yoke and input shaft provide a coarse alignment during installation. The guide cap fin 26 may extend approximately to the distal tip of the input shaft 12. Accordingly, for the yoke 14 to fit to the input shaft, the yoke slit 88 must be aligned with the fin 26. The distal edges of the fin 26 first encountered by the yoke 14 during installation may be chamfered to ease the mating of the fin 26 into the slit 88 as the yoke 14 is positioned and moved along the input shaft 12.

As noted above, the end portion 50 of input shaft 12 has a distal portion 58 with a smaller diameter than that of a proximal portion 60. The diameter and shape of the yoke's axial channel generally conforms to that of the distal portion 58. Thus, eventually as the yoke 14 is moved axially along the input shaft 12, the yoke will encounter either the cap body 24 or the wider diameter proximal portion 60. In a preferred embodiment, the yoke 14 first encounters the input shaft 12, rather than the guide cap 16. In such embodiment the yoke 14 encounters a transition region between the narrow diameter distal portion 58 and the wider diameter proximal portion 60 of the input shaft 12. Note, however, that when the yoke bolt 20 is installed the yoke 14 may be displaced axially as needed away from such encountered transition region. Also note that this transition region differs from that where the cap 16 is seated. Thus, the inputs shaft 12 may have at least axial length portion of differing diameter. For example, the end portion 50 may encompass two of such length portion with the border between the end portion 50 and the remainder of the input shaft being the transition region where the cap body 24 seats.

With the yoke 14 situated on the input shaft 12 in a rotational alignment coarsely determined by corresponding flat surfaces and finely determined by the fin 26, the yoke bolt 20 may be installed next. The yoke bolt 20 is inserted into the yoke bolt channel 86 and slid through a first length 91 of the channel 86 into the area of the intersecting slit 88. Also in such area the yoke bolt 20 encounters the whistle notch 22 of the input shaft. If the yoke 14 is precisely aligned, the whistle notch tangential surface is substantially parallel to the transverse direction of the yoke bolt channel 86. The yoke bolt channel 26 is radially offset from the center of the yoke's axial channel 25 so that when properly aligned the yoke bolt 20 slides along or offset from the whistle notch 22 for the entire length of the encounter with the whistle notch exposed area without digging into the whistle notch 22. The yoke bolt 20 slides through such slit area and into the second length 93 of the yoke bolt channel 86, where it encounters threads 95. The yoke bolt 20 then continues the rest of the way into the yoke bolt channel 86 with the yoke bolt threads screwing onto the yoke bolt channel threads 95. The yoke bolt 20 may be screwed inward to a desired torque force to tighten the yoke bolt 20 and thereby tighten the yoke 14 relative to the input shaft 12. For example, as the yoke bolt 20 is tightened the lengths 91 and 93 are moved together narrowing the slit 88 and slightly reducing the yoke axial channel 29 cross sectional area (e.g., diameter) so as to fit tighter to the input shaft surfaces.

If precise rotational alignment is not provided for the yoke 14, then the whistle notch tangential surface and the transverse direction of the yoke bolt channel 86 will not be parallel and the yoke bolt 20 may thread into the input shaft 12. For example, if not in rotational alignment the yoke bolt 20 may thread into the input shaft at either a first encountered exposed area of the whistle notch 22, or at a portion encountered thereafter. Such problem has been described above more fully in a separate section.

With the yoke bolt 20 tightened the yoke 14 is secured to the input shaft 12. The guide cap 16 assures that the yoke bolt has been positioned in proper rotational relationship with the whistle notch 22. The guide cap's fin notch 38 provides limits to axial and radial displacement of the yoke bolt 20 relative to the axial position of the whistle notch 22. The yoke is machined so that the yoke bolt channel 86 is at a sufficient radial distance relative to the whistle notch 22 so as to avoid threading into the whistle notch 22 when rotationally positioned to a given tolerance. Such fine rotational positioning is achieved by the relationship between the fin anchor 42 and the longitudinal groove 52 of the input shaft 12. The fin anchor 42 in turn aligns the fin 26. The fin 26 fits snugly in the slit 88 so that such fine rotational tolerances are achieved. As a result a fine, precise rotational position of the yoke bolt channel 86 is achieved so that the yoke bolt 20 is both radially and rotationally positioned relative to the whistle notch 22 to assure an aligned installation.

Once the yoke 14 and guide cap 16 are installed on the end of the input shaft 12, the input shaft engaging members 28 grip the input shaft 12. The members' projections 31 rest in the circumferential groove 32 and in the sample embodiment resist axial separation forces up to 780 N.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, materials and/or embodiments, the invention is not intended to be limited to the particulars disclosed herein. The invention is intended to extend to all functionally equivalent structures, methods and uses, such as are within the scope of the appended claims. Those skilled in the art, having the benefit of the teachings of this specification, may affect numerous modifications thereto and changes may be made in form and details without departing from the scope and spirit of the invention.

1. A guide cap for axially aligning a yoke to an input shaft of a steering system, the guide cap comprising:
a cap body having an axially aligned through-opening that receives an end portion of the input shaft;
a protrusion extending radially inward that engages a radial recess in the input shaft with a retention force opposing axial removal of the guide cap once installed; and
a fin extending from the cap body and guiding seating of the yoke to the input shaft by mating to a yoke slit; and
wherein the fin comprises: a fin notch that for accommodating a portion of a yoke bolt that secures the yoke to the input shaft; and a fin anchor that mates to a groove of the input shaft providing stability to the fin relative to the input shaft.

2. The guide cap of claim 1, wherein the fin as situated within the slit of the yoke links rotational motion of the guide cap and yoke.

3. The guide cap of claim 1, wherein the fin anchor is configured to seat in the input shaft groove in a manner providing fine rotational positioning of the guide cap relative to the input shaft while limiting rotational play between the guide cap and the input shaft.

4. The guide cap of claim 1, wherein the cap body and fin anchor set an axial, radial, and rotational relationship between the fin notch and the input shaft adapting the fin notch to limit relative position of the yoke bolt and input shaft.

5. The guide cap of claim 1, further comprising a finger projection, the finger projection comprising said protrusion.

6. The guide cap of claim 1, wherein the cap body has an asymmetrical inner circumferential surface.

7. A guide cap for axially aligning a yoke to an input shaft of a steering system, the yoke having an axially aligned opening for receiving the input shaft, a bolt channel for receiving a yoke bolt, and a yoke slit, the bolt channel extending to each side of the yoke slit and having a threaded wall at one side of the yoke slit, the guide cap comprising:
a cap body, a fin, and a finger projection, the fin extending from the cap body and having a fin notch and a fin anchor; and
wherein the cap body has an axially aligned through-opening adapted for receiving an end portion of the input shaft;
wherein the fin is adapted to provide alignment of the yoke to guide seating of the yoke to the input shaft by mating to the yoke slit;
wherein the finger projection is adapted for engaging a radial recess in the input shaft with a retention force opposing axial removal of the guide cap once installed;
wherein the fin notch has a shape configured to accommodate a cross section of a yoke bolt that secures the yoke to the input shaft while the yoke bolt is in the bolt channel; and
wherein the fin anchor is adapted for mating to a groove of the input shaft to provide stability to the fin relative to the input shaft.

8. The guide cap of claim 7, wherein the finger projection minimizes axial displacement of the guide cap relative to the input shaft in at least a separating direction.

9. The guide cap of claim 7, wherein rotational motion of the guide cap and yoke are directly linked together while at least a portion of the fin is mated to the yoke slit.

10. The guide cap of claim 7, wherein the fin anchor is configured to seat in the input shaft groove in a manner providing fine rotational positioning of the guide cap relative to the input shaft while limiting rotational play between the guide cap and the input shaft.

10. The guide cap of claim 6, wherein the cap body and fin anchor set a radial relationship between the fin notch and the input shaft so as to bound the yoke bolt within the fin notch along a path capable of being radially spaced from the input shaft.

12. A steering system comprising:
an input shaft;
a yoke having a first portion that connects to the input shaft, and having an axially-aligned opening, a slit, and a bolt channel, the bolt channel extending to each side of the slit and having a threaded wall at a first side of the slit;
a yoke bolt mated to the bolt channel, passing through a portion of the slit, and being secured by the threaded wall; and
a guide cap, comprising:
a cap body having an axially aligned through-opening that receives an end portion of the input shaft;
a protrusion extending radially inward that engages a radial recess in the input shaft supporting axial retention of the guide cap relative to the input shaft and minimizing axial displacement of the guide cap relative to the input shaft in at least a separating direction; and
a fin extending from the cap body and guiding seating of the yoke to the input shaft by mating to the slit; and
wherein the fin comprises: a fin notch that has a shape configured to accommodate a portion of a yoke bolt; and a fin anchor that mates to a groove of the input shaft providing stability to the fin relative to the input shaft.

13. The guide cap of claim 12, wherein the fin as situated within the slit of the yoke links rotational motion of the guide cap and yoke.

14. The guide cap of claim 12, wherein the fin anchor is configured to seat in the input shaft groove in a manner providing fine rotational positioning of the guide cap relative to the input shaft while limiting rotational play between the guide cap and the input shaft.

15. The guide cap of claim 12, wherein the cap body and fin anchor set an axial, radial, and rotational relationship between the fin notch and the input shaft adapting the fin notch to limit relative position of the yoke bolt and input shaft.

16. The guide cap of claim 12, further comprising a finger projection, the finger projection comprising said protrusion.

17. The guide cap of claim 12, wherein the cap body has an asymmetrical inner circumferential surface and the end portion of the input shaft includes an asymmetrical outer surface region, wherein the guide cap fits to the input shaft at only one cap orientation due to a correspondence between at least a portion of the asymmetrical inner circumferential surface and the asymmetrical outer surface region, and wherein the fin anchor is configured to seat in the input shaft groove in a manner providing fine rotational positioning of the guide cap having said one cap orientation.
